(19) United States
(12) Patent Application Publication
(10) Pub. No.: US 2006/0188734 A1
(43) Pub. Date: Aug. 24, 2006

(54) Metallized ionomer laminates, composite articles, and processes for making the same

(76) Inventors: Jeffrey Valentage, Royal Oak, MI (US); Joseph Dominic Domine, Humble, TX (US); Richard Vernon Gebben, Fairport, NY (US)

Correspondence Address: EXXONMOBIL CHEMICAL COMPANY, 5200 BAYWAY DRIVE, P.O. BOX 2149, BAYTOWN, TX, 77522-2149, US

(21) Appl. No.: 11/318,919

(22) Filed: Dec. 27, 2005

Related U.S. Application Data
(60) Provisional application No. 60/639,520, filed on Dec. 28, 2004.

(51) Int. Cl. B32B 15/08; B32B 27/30; B05D 3/00; B05D 3/12

(52) U.S. Cl. 428/457; 428/522; 428/463; 427/294; 427/356

(57) ABSTRACT

The present invention relates to new laminates formed from at least one ionomer layer including a metallized ionomer layer, one or more tie layers, and optionally a backing layer. The present invention also relates to new composite articles made from these laminates in combination with optional substrate materials.

### CROSS REFERENCE TO RELATED APPLICATIONS

This application claims the benefit of Provisional Application No. 60/639,520 filed Dec. 28, 2004.

### FIELD OF THE INVENTION

The present invention is directed generally to metallized ionomer laminates and composite articles including such laminates. The present invention is also directed to methods of forming the metallized laminates and methods of forming the composite articles.

### BACKGROUND OF THE INVENTION

Metallized articles prepared by applying a metal to a plastic material using conventional metallizing techniques are well known. Such articles are commonly used as substitutes for articles that are expected to have a metal-plated appearance, e.g., automobile grills and bumpers. These decorative polymeric articles are becoming standard in some industries because polymers are relatively flexible, corrosion-resistant, and inexpensive. In the automobile industry, plastic parts also provide enhanced vehicle performance, such as fuel economy and towing/hauling capacity, because they are relatively lighter in weight.

Ionomers are known to be useful in metallized substrates. For example, U.S. Pat. No. 6,761,793 describes a metallized composite including a thermoplastic sheet and at least one discontinuous layer of metal within the thermoplastic sheet. Ionomers are given as an example of a suitable thermoplastic polymer. The metallized composite can be supported by a substrate, whereby the metallized composite is in contact with the substrate.

Other references of interest include: US2004/113899; U.S. Pat. No. 5,182,145; US 2003/031891; WO 02/083426; and Japanese Abstract 03175025 (published Jul. 7, 1991).

US 2004/113899 is directed to a display member having metallic luster, comprising a substrate, a metallic layer and a transparent layer and discloses, among other things, an adhesive layer in contact with the metallic layer made of polyamide, nylon, polyurethane, vinyl chloride, or vinyl acetate resin.

U.S. Pat. No. 5,182,145 is directed to a bright tape for molding typically comprising an ionomer resin layer polymerized on a metallized film and a vinyl chloride sheet laminated by an adhesive agent on the outer surface of the metallized film from where the synthetic resin film has been peeled off.

US 2003/031891 is directed to a laminate comprising a plurality of discontinuous metal island layers deposited on a formable clear coat film, specifically the reference discloses a metallized laminate that can include an adhesive layer between a second discontinuous metal layer and a thermoplastic backing layer. Pressure sensitive adhesives, heat-reactive adhesives, and multicomponent adhesives formed from blends of polymers are disclosed.

WO 02/083426 is directed to a substrate comprising a polymeric core having a first and a second surface, an inkjet coating is on the first surface, and a metallized layer covers at least a portion of the second substrate.

The abstract of JP 03175025 appears to disclose a core material having a layer of ionomer resin laminated to the core material which then has a vaporized chrome second layer attached to the ionomer layer.

Ionomers are useful as metallized substrates because of their scratch and abrasion resistance, as well as their toughness and aesthetic appeal. A continued problem, however, is bonding the ionomer sheet or layer to a substrate. Therefore, a need exists for a metallized ionomer laminate that overcomes or minimizes this problem.

### SUMMARY OF THE INVENTION

In an embodiment, the invention relates to a laminate comprising a metallized ionomer layer and a tie layer.

In another embodiment, the invention relates to a composite article comprising a laminate and a substrate, wherein the laminate comprises a metallized ionomer layer and a tie layer.

In yet another embodiment, the invention relates to a method of forming a composite article. The method comprises depositing a metal on an ionomer layer to form a metallized ionomer layer, securing the metallized ionomer layer to a tie layer to form a laminate, and securing a substrate layer to the laminate to form the composite article.

### DETAILED DESCRIPTION OF THE INVENTION

Various specific embodiments of the invention will now be described, including exemplary embodiments and definitions that are adopted herein for purposes of understanding the claimed invention. However, for purposes of determining infringement, the scope of the “invention” will refer to the appended claims, including their equivalents, and elements or limitations that are equivalent to those that are recited. Any reference to the “invention” may refer to one or more, but not necessarily all, of the inventions defined by the claims. References to specific “embodiments” are intended to correspond to claims covering those embodiments, but not necessarily to claims that cover more than those embodiments.

As used herein, the term “Groups” or “Group”, when used in describing chemical elements, refers to the new numbering scheme for the Periodic Table Groups as in HAWLEY'S CONDENSED CHEMICAL DICTIONARY 852 (13th ed. 1997).

As used herein, the term “laminate” refers to any number of the same or different materials in film, sheet, or layer form, each layer being secured to one another by any appropriate means such as by an inherent tendency of the materials to adhere to one another, or by inducing the materials to adhere as by a heating, radiative, chemical, or some other appropriate process. Some non-limiting process examples of forming laminates are coextrusion, thermal lamination, or adhesive bonding, or some combination thereof.

As used herein, the term “layer” refers to each of the one or more materials, the same or different that are secured to one another by any appropriate means. The term “layer” is not limited to detectable, discrete materials contacting one another in a finished product such that a distinct boundary exists between the materials. The term “layer” includes a finished product having a continuum of materials throughout its thickness.

As used herein, the term “tie layer” refers to a layer bonded to the ionomer layer(s) which may or may not be metallized. In most embodiments that include a backing layer, the backing layer is bonded to the ionomer layer(s) with the tie layer. In some embodiments that include a substrate, the substrate is bonded to the ionomer layer(s) with the tie layer. Each tie layer may comprise multiple layers.

As used herein, “backing layer” refers to a tie layer that forms the surface opposite from the ionomer surface of the multilayered laminate. In most embodiments, the backing layer requires a tie layer of a different composition to bond it to the ionomer layer(s).

As used herein, “composite article” refers to an article formed from a multilayer laminate secured to a substrate.

As used herein, “substrate” refers to that part of the composite article that is behind the multilayered laminate, and typically provides the largest proportion of the mass of the composite article. It therefore governs the range of many of the physical properties of the composite article such as stiffness, tensile strength, impact strength, etc. Surface properties of the composite article, such as gloss, scratch resistance, abrasion resistance, color, appearance, “flop”, are usually unaffected by the substrate.

As is well known in the art, the demarcation between “film” and “sheet” is nominally 250 μm. However, as used herein the term “sheet” can refer to single layered or multilayered structures with thicknesses that are greater than, equal to or less than 250 μm.

As used herein, the term “polymerization” includes homopolymerization, copolymerization, terpolymerization, and interpolymerization.

As used herein, the term “polymer” may be used to refer to homopolymers, copolymers, interpolymers, terpolymers, etc. Likewise, a copolymer may refer to a polymer comprising at least two monomers, optionally with other monomers. Polymer may also refer to one or more polymers regardless of the method, time, and apparatuses used to combine the polymers. Additionally, polymer may be used to refer to polymeric compositions.

When a polymer is referred to as comprising a monomer, the monomer is present in the polymer in the polymerized form of the monomer or in the derivative form the monomer. However, for ease of reference the phrase comprising the (respective) monomer or the like is used as shorthand.

As used herein, the term “elastomer,” “rubber,” or “elastomeric composition,” refers to any polymer or composition of polymers consistent with the ASTM D1566 definition. The terms may be used interchangeably with the term “rubber(s)”, as used herein.

In an embodiment, the composite article provides for a multilayered sheet secured to a substrate. The multilayered sheet provides for a metallized ionomer surface layer, and a tie layer laminated onto the metallized surface of the ionomer layer. The multilayered sheet is secured to a substrate.

In another embodiment, the composite article provides for a multilayered sheet including a backing layer. The multilayered sheet provides for a metallized ionomer layer (surface layer), a tie layer laminated onto the metallized surface of the ionomer layer, and a backing layer.

In another embodiment, the composite article provides for a multilayered sheet secured to a substrate. The multilayered sheet provides for a set of ionomer layers comprising a surface layer of clear ionomer, a sub-surface layer of metallized ionomer, and a tie-layer. In a particular aspect of this embodiment, the metallized surface of the sub-surface metallized ionomer layer is secured to the surface layer of ionomer. In another particular aspect of this embodiment, the metallized surface of the sub-surface metallized ionomer layer is secured to the tie layer. The multilayered sheet, optionally containing a backing layer, is secured to a substrate.

Ionomer

Ionomers useful in the present invention are ionic compounds which are copolymers of C₂ to C₄ α-olefin derived units (ethylene is herein included as an “α-olefin”), and C₃ to C₆ α,β-ethylenically unsaturated carboxylic acids, and which contain one or more kinds of metallic or organic cations associated with at least 5% of the acidic pendant groups of the polymer. Typical ionomers and methods of production are disclosed in, for example, U.S. Pat. Nos. 3,264,272, 4,911,451, 5,210,138, and 5,929,174; and WO 98/52981, 95/11929, 96/23009, 97/11995, and 97/02317, and described in COMPREHENSIVE POLYMER SCIENCE 755-772 (Colin Booth & Colin Price, ed. Pergamon Press 1989), in particular relating to ethylene-based materials.

The metal ion or ions suitable for forming the ionic copolymers of the present invention comprise mono, di or tri-valent metal ions in the Groups 1 through 13 of the Periodic Table of Elements. Embodiments include the following metal ions: Na⁺, K⁺, Li⁺, Cs⁺, Ag⁺, Hg⁺, Cu⁺, Be²⁺, Mg²⁺, Ca²⁺, Sr²⁺, Ba²⁺, Cu²⁺, Cd²⁺, Hg²⁺, Pb²⁺, Fe²⁺, Co²⁺, Ni²⁺, Zn²⁺, Al²⁺Sc³⁺, Fe³⁺, Al³⁺ and Yt³⁺. In the various ions mentioned above, Mg²⁺, Na⁺ and Zn²⁺ are metals used in desirable embodiments.

The ionomers useful in the present invention, either alone or as a blend of two or more ionomers, generally include more than 20 wt % α-olefin derived units in one embodiment by weight of the ionomer, and more than 40 wt % α-olefin derived units in another embodiment, and more than 50 wt % α-olefin derived units in another embodiment, and more than 60 wt % α-olefin derived units in another embodiment, and more than 80 wt % α-olefin derived units in another embodiment, and less than 95 wt % α-olefin derived units in another embodiment, and less than 85 wt % α-olefin derived units in another embodiment, and less than 75 wt % α-olefin derived units in yet another embodiment, and from 20 to 95 wt % α-olefin derived units in another embodiment, and from 75 to 95 wt % α-olefin derived units in another embodiment, wherein a desirable range of α-olefin derived units that make up the ionomer is any combination of any upper limit with any lower limit described herein; and from 5 to 25 wt % of α,β-ethylenically unsaturated carboxylic acid derived units in one embodiment, and from 1 to 15 wt % of α,β-ethylenically unsaturated carboxylic acid derived units in another embodiment, and from 8 to 20 wt % of α,β-ethylenically unsaturated carboxylic acid derived units in another embodiment, wherein a desirable embodiment of a useful ionomer may comprise any upper wt % limit and any lower wt % limit of any α,β-ethylenically unsaturated carboxylic acid derived units described herein.

Reaction of the carboxylic acid groups of the ionomer and a metal ion derived from a desirable metal compound (metal oxide, metal chloride, etc.) is referred to as “neutralization.” The polymer may be neutralized to form the ionomer to any degree between 10% to 90% based on the total amount of neutralizable carboxylate groups in one embodiment, and from 20% to 80% in another embodiment, and from 40% to 75% in yet another embodiment, and from 5% to 70% in yet another embodiment, provided the necessary scratch and mar resistance is maintained. A desirable level of neutralization may include any upper neutralization % limit and any lower neutralization % limit described herein.

One embodiment of an ionomer can be described as in the following structure (1): 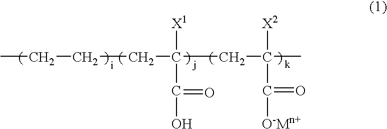
wherein X¹ and X² can be the same or different and are hydrogen or a C₁ to C₆ alkyl, and Mⁿ⁺ is a metal ion or NH₄⁺. Of course, it is understood that when n is >1, such as with a divalent metal ion such as Zn²⁺, that charge neutrality for the ionomer is achieved by reaction with a total of n acid groups from either the same polymer chain, or an adjacent polymer chain (typically n may be 1, 2, 3, 4, 5 or 6). The structure (1) is not intended to be construed that the ionomer is a block copolymer or limited to being a block copolymer. The values of i, j, and k are determined by the following relationships (2) and (3):

$$\begin{matrix}\frac{j + k}{i + j + k} = Q & ( 2 ) \\ \frac{k}{j + k} = P & ( 3 )\end{matrix}$$

wherein Q is from 10 to 40% of the polymer units derived from the acidic monomer(s) relative to the total weight of the ionomer in one embodiment, and from 15 to 20% of polymer units derived from the acidic monomer(s) in another embodiment, and P is from 10 to 80% of the acidic groups neutralized with the metallic ions in one embodiment, and from 20 to 70% of the acidic groups neutralized with the metallic ions in another embodiment, and from 20 to 60% in yet another embodiment, and further ranges as stated above. The polymer component i, derived from ethylene in one embodiment, can be linear or branched.

Useful ionomers or ionomer blends have a peak melt temperature of greater than 75° C. in one embodiment, and between 75° C. and 200° C. in another embodiment, and between 75° C. and 150° C. in one embodiment, and between 80° C. and 95° C. in another embodiment, and between 80° C. and 88° C. in another embodiment. Useful ionomers or ionomer blends typically have a melt index (MI) of between 0.1 dg/min and 30 dg/min (ASTM D1238, 190/2.16) in one embodiment, from 0.2 to 8 dg/min in one embodiment, from 0.5 to 5 dg/min in another embodiment, from 0.5 to 3 dg/min in another embodiment, and from 0.8 to 2.5 dg/min in yet another embodiment, wherein a desirable range may be any combination of any upper MI limit with any lower MI limit described herein.

The ionomers useful in the present invention should provide high scratch and impact resistance, and/or high gloss, and/or high abrasion resistance to the laminate and composite article. The ionomers or ionomer blends have a 1% secant flexural modulus (ASTM D-790) of greater than 100 MPa in one embodiment, and greater than 300 MPa in another embodiment, and greater than 400 MPa in another embodiment, and between 150 and 400 MPa in one embodiment, and from 200 to 350 MPa in another embodiment. In yet another embodiment, the ionomer or blends of ionomers have a 1% secant flexural modulus of greater than 1,000 MPa, such as greater than 2,000 MPa, and greater than 4,000 MPa. Desirable ionomers are ethylene methacrylic acid copolymer ionomers and ethylene acrylic acid copolymers ionomers and the like. Particularly desirable ionomers are those that are sodium or zinc salts of acrylic acid or methacrylic acid copolymers.

Further, certain blends of ionomers based on ethylene acrylic acid copolymer neutralized with divalent and monovalent metal ions (cations) such as Zn²⁺ and Na⁺, display a synergistic MI “uplift” as disclosed in, for example, U.S. Pat. Nos. 5,210,138, and 5,929,174 are useful. In one embodiment of the invention, one or more of the ionomer layers that make up the laminate is a blend of a first ionomer having an MI value of from 0.6 to 1.0 dg/min, and a second ionomer having an MI value of from 2.1 to 3.0 dg/min. The blend of the first and second ionomers includes from 45 wt % to 95 wt % of the first ionomer in one embodiment, and from 55 wt % to 85 wt % of the first ionomer in another embodiment, and from 65 wt % to 80 wt % of the first ionomer in yet another embodiment, and from 72 wt % to 78 wt % of the first ionomer in yet another embodiment, and 75 wt % of the first ionomer in yet another embodiment, wherein a desirable range may include any upper wt % limit and any lower wt % limit described herein. The blends may include blends of two or more ionomers having different metallation (different metals and/or different % of metallation), different MI values, or a combination of variables.

Other examples of ionomers useful in the present invention include, but are not limited to, butadiene-acrylic acid copolymer ionomers, perfluorsulfonate ionomers, perfluorocarboxylate ionomers, telechelic polybutadiene ionomers, sulfonated ethylene-propylene-diene terpolymer ionomers, styrene-acrylic acid copolymer ionomers, sulfonated polystyrene ionomers, sulfonated polypentenamer ionomers, telechelic polyisobutylene sulfonated ionomers, alkyl methacrylate-sulfonate copolymer ionomers, styrene-based polyampholytes ionomers and acid-amine ionomers and the like. Typical examples of ionomers employing salts of carboxylic acid type pendent groups are disclosed in GB 1,011,981; U.S. Pat. Nos. 3,264,272; 3,322,734; 3,338,734; 3,355,319; 3,522,222; and 3,522,223. Typical examples of ionomers employing phosphonate-type pendent groups include those disclosed in U.S. Pat. Nos. 3,094,144; 2,764,563, 3,097,194; and 3,255,130. Typical examples of ionomers employing sulfonate-type pendent groups include those disclosed in U.S. Pat. Nos. 2,714,605; 3,072,618; and 3,205,285. Other useful ionomers are disclosed generally in U.S. Pat. Nos. 5,631,328, 5,631,328, 5,554,698, 4,801,649, 5,320,905, 5,973,046, and 4,569,865.

Ionomers comprising copolymers of ethylene derived units and acrylic acid (AA) derived units are desirable. Examples of commercially available ionomers include, but are not limited to, IOTEK ionomers (ExxonMobil Chemical Company, Houston, Tex.), such as IOTEK 8000, a 45% sodium neutralized ethylene-based ionomer of 15 wt % acrylic acid (prior to neutralization), and IOTEK 7030, a 25% zinc neutralized ethylene-based ionomer of 15 wt % acrylic acid, and SURLYN ionomers (DuPont Company, Wilmington, Del.).

The one or more ionomer layers may contain additives such as antioxidants, pigments or dyes, and other agents. In one embodiment, at least one layer of ionomer in the final composite article will have a pigment, antioxidant, or other additives. For external uses, it is desirable to add a UV stabilizer such as TINUVEN 791 (CIBA Specialty Chemicals) or UVASIL 2000 HM or LM (Great Lakes Chemicals), both silicon based compositions. Also, for scratch resistance, it is advantageous to add siloxane based compositions such as MB50-001 and/or MB50-321 (Dow Corning Corporation). Effective levels are known in the art and depend on the details of the base polymers, the fabrication mode and the requirements of the end application. In addition, hydrogenated and/or petroleum hydrocarbon resins and other plasticizers may be used as modifiers.

Other examples of additives include one or more of the following: heat stabilizers or antioxidants, neutralizers, slip agents, antiblock agents, pigments, antifogging agents, antistatic agents, clarifiers, nucleating agents, ultraviolet absorbers or light stabilizers, fillers, rosins or rosin esters, waxes, additional plasticizers and other additives in conventional amounts.

Tie-Layer

In one embodiment, the tie layer includes one or more acid polymers. Acid polymers represent a broad class of compounds typically formed by copolymerization of unsaturated carboxylic acid and at least one α-olefin. Desirably, the carboxylic acid may be formed from a carboxylic acid alone or in combination with an ester. More particularly, the acid polymer may be an acid terpolymer represented by the following structure (4): 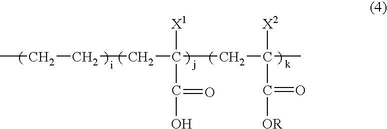
wherein X¹ and X² can be the same or different and are hydrogen or a C₁ to C₆ alkyl, R can be a C₁ to C₁₀ normal alkyl or branched alkyl in one embodiment, and a C₁ to C₄ normal alkyl or branched alkyl in another embodiment, j has a value of from 5 to 15% relative to the acid terpolymer weight, and k has a value of from 5 to 25%, and i has a value of from 65 to 90%. The structure (4) is not intended to be construed that the acid polymer is a block copolymer or limited to being a block copolymer. In one embodiment, the acid polymer may be partially neutralized, creating a so called “soft ionomer,” or partially neutralized acid polymer, wherein the degree of neutralization is from 10 to 75%. The neutralized carboxylic acid groups can be characterized as above for the ionomer. So called soft ionomers are disclosed in, for example, WO 97/02317.

The acid polymer preferably has a melt index (MI) of from 0.1 to 40 dg/min in one embodiment, from 1 to 30 dg/min in another embodiment, from 2 to 20 dg/min in yet another embodiment, and from 2.5 to 10 dg/min in yet another embodiment (ASTM D1238, 190/2.16), a desirable range including a combination of any upper MI limit and any lower MI limit disclosed herein.

In one embodiment, the acid polymer is an acid terpolymer, which includes terpolymers of ethylene, alkyl acrylate, particularly methyl acrylate, and acrylic acid, such as disclosed in U.S. Pat. Nos. 5,397,833, and 5,281,651, and herein referred to as “EAAT”. Other useful acid polymers are disclosed in U.S. Pat. Nos. 4,307,211, and 5,089,332. In a particular aspect of this embodiment, the acid polymer is a terpolymer of ethylene, alkyl acrylate, and acrylic acid, wherein the alkyl acrylate is selected from methyl acrylate, ethyl acrylate, propyl acrylate, butyl acrylate and combinations thereof.

In one embodiment, the acid polymer is an ethylene/methyl acrylate/acrylic acid (E/MA/AA) terpolymer having an acrylate content of from 4 to 40 wt %, or from 5 to 35 wt %, or from 5 to 25 wt %, based on the weight of the entire polymer. In a particular aspect of this embodiment, the acrylic acid content of the terpolymer is from 1 to 15 wt %, or from 1 to 10 wt %, or from 5 to 15 wt %, or from 2 to 8 wt %, based on the weight of the entire polymer.

The E/MA/AA terpolymer may comprise a wide range of melt indexes (MI), generally between 0.1 to 100 dg/min in one embodiment, from 0.1 to 30 dg/min in one embodiment, and from 1 to 10 dg/min in another embodiment, and from 0.5 to 5 dg/min in yet another embodiment (ASTM D1238, 190/2.16), a desirable MI embodiment of the terpolymer comprising any upper MI limit with any lower MI limit described herein.

Commercial examples of acid polymers useful in the tie-layer include, but are not limited to, ESCOR AT 310 resin having 6.5 wt % methyl acrylate derived units and 6.5 wt % acrylic acid derived units, and ESCOR AT 320 having 18 wt % methyl acrylate derived units and 6 wt % acrylic acid derived units, both are ethylene acid terpolymers (ExxonMobil Chemical Company, Houston, Tex.). Soft ionomers are commercially available as IOTEK 7510, a 69% zinc neutralized acid terpolymer of 6 wt % acrylic acid and 20 wt % methyl acrylate (prior to neutralization), and IOTEK 7520, a 43% neutralized acid terpolymer of 6 wt % acrylic acid and 20 wt % methyl acrylate, also available from ExxonMobil Chemical Company.

In another embodiment, the tie layer includes one or amine-containing polymers. Amine-containing polymers are copolymers of one or more C₂-C₁₀ α-olefins, preferably ethylene and/or propylene, and one or more ethylenically copolymerizable amine-containing monomer, the copolymer having amine groups that may be represented by the general formula: 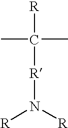
where each R is independently H or a C₁ to C₁₀ hydrocarbon and R′ is a bond or a C₁ to C₁₀ hydrocarbon.

In a preferred embodiment, R is H and R′ is a bond.

In another embodiment, the tie layer includes epoxy-containing copolymers, terpolymers, or mixtures thereof. Epoxy-containing copolymers and terpolymers may be produced by direct copolymerization of C₂-C₁₀ α-olefins, preferably ethylene and/or propylene, and epoxy-containing monomers such as glycidyl acrylate or glycidyl methacrylate, and for terpolymers, with other ester monomers. Epoxy-containing monomers may be represented by the general formula: 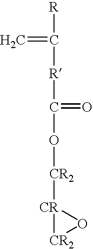
where each R is independently H or a C₁ to C₁₀ hydrocarbon and R′ is independently a bond or a C₁ to C₁₀ hydrocarbon. The polymers of this invention may be made using mixtures of monomers with different R and R′ groups.

Alternatively, epoxy-containing polymers may be made with an ester monomer to form an epoxy-containing terpolymer. The ester monomer may be represented by the general formula: 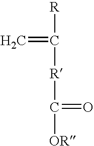
where each R is independently H or a C₁ to C₁₀ hydrocarbon; each R′ is independently a bond or a C₁ to C₁₀ hydrocarbon; and R″ is a C₁ to C₁₀ hydrocarbon. The polymers of this invention may be made using mixtures of monomers with different R, R′ and R″ groups.

Preferred embodiments of epoxy-containing polymers include the copolymers of ethylene and/or propylene with one or more ester monomers methyl (meth)acrylate, ethyl (meth)acrylate, propyl (meth)acrylate, or butyl (meth)acrylate.

Epoxy-containing polymers may also be produced by grafting epoxy-containing monomers onto C₂-C₁₀ α-olefins polymers, preferably ethylene and/or propylene polymers and/or copolymers of C₂-C₁₀ α-olefins with polar monomers such as vinyl esters and other ester monomers. These grafted, epoxy-containing polymers may be represented by the general formula:

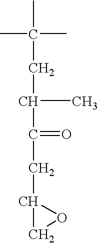

In some embodiments, polymer molecules can be grafted with an epoxy-containing monomer, such as glycidyl methacrylate, in several places along the polymer chain.

Preferable embodiments include glycidyl methacrylate grafted onto polyethylene or a copolymer of ethylene with one or more ester monomers methyl (meth)acrylate, ethyl (meth)acrylate, propyl (meth)acrylate, or butyl (meth)acrylate.

In another embodiment, the tie layer includes one or more acidic copolymers. Acidic copolymers include bipolymers of C₂-C₁₀ α-olefins, preferably ethylene and/or propylene, and acidic monomers that may be represented by the general formula: 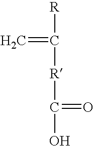
where R is H or a C₁ to C₁₀ hydrocarbon and R′ is a bond or a C₁ to C₁₀ hydrocarbon.

In some embodiments, the polymers of this invention may be made using mixtures of acid monomers with different R and R′ substituents. Preferred embodiments are ethylene and/or propylene copolymerized with acrylic acid and/or methacrylic acid.

In another embodiment, the tie layer includes one or more copolymers of C₂-C₁₀ α-olefins, preferably ethylene and/or propylene, and ethylenically copolymerizable ester monomers represented by the general formula: 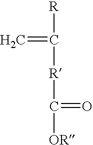
where R is H or a C₁ to C₁₀ hydrocarbon; R′ is a bond or a C₁ to C₁₀ hydrocarbon; and R″ is a C₁ to C₁₀ hydrocarbon.

The polymers of this invention may be made using mixtures of ester monomers with different R, R′ and R″ groups. Preferred embodiments are ethylene and/or propylene copolymerized with one or more of ester monomers methyl (meth)acrylate, ethyl (meth)acrylate, propyl (meth)acrylate, or butyl (meth)acrylate.

In another embodiment, the tie layer includes one or more copolymers of C₂-C₁₀ α-olefins, preferably ethylene and/or propylene, and vinyl ester monomers represented by the formula: 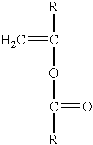
where each R is independently H or a C₁ to C₁₀ hydrocarbon.

Alternatively, vinyl ester copolymers may be made with other ester monomers to form terpolymers. The other ester monomer may be represented by the general formula: 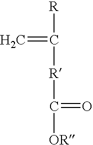
where R is H or a C₁ to C₁₀ hydrocarbon; R′ is a bond or a C₁ to C₁₀ hydrocarbon; and R″ is a C₁ to C₁₀ hydrocarbon.

The polymers of this invention may be made using mixtures of vinyl ester monomers and other ester monomers with different R, R′ and R″ groups. Preferred embodiments include ethylene or propylene copolymerized with vinyl acetate optionally with butyl (meth)acrylate.

In another embodiment, the tie layer includes one or more grafted polymers of C₂-C₁₀ α-olefins, preferably ethylene and/or propylene, (such as LDPE, LLDPE, HDPE, PP, PP copolymers, EPR or EPDM), ethylene vinyl ester copolymers (based on from C₁ to C₁₀ acids), ethylene (meth)acrylate ester copolymers (made from C₁ to C₁₀ alcohols) grafted with (meth)acrylic acid represented by the general formula: 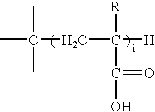
where each R is independently H or a C₁ to C₁₀ hydrocarbon and i is from 1 to 5. Each polymer molecule can be grafted with methacrylic acid in several places along the polymer chain

In another embodiment, the tie layer includes one or more polymers made with unsaturated diacids, anhydrides of unsaturated diacids, or monoesters of unsaturated diacids. Suitable unsaturated diacids include, but are not limited to, maleic acid, itaconic acid, citraconic acid and 2-pentenedioic acid and their corresponding anhydrides and monoesters. Illustrative examples may be represented by the general formulas: 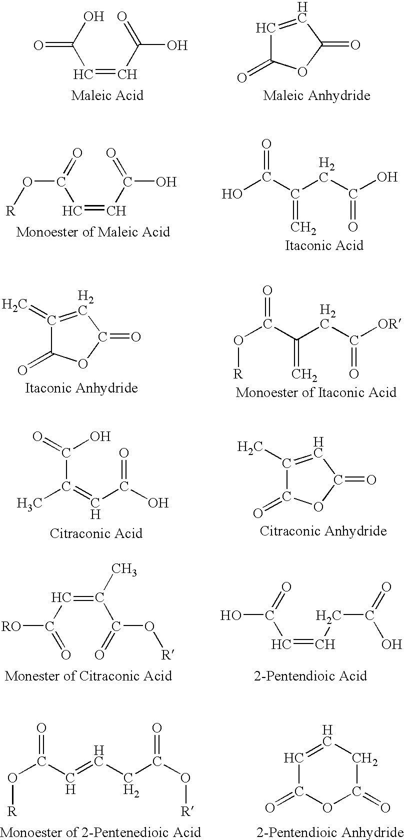
wherein each R and R′ is independently H or a C₁ to C₁₀ hydrocarbon; wherein each R and R′ are different.

In another embodiment, the tie layer includes one or more copolymers of one or more C₂ to C₁₀ α-olefins and carbon monoxide. These copolymers may be optionally copolymerized with one or more ethylenically copolymerizable acidic or ester monomers.

Ethylenically copolymerizable acidic monomers may be represented by the general formula: 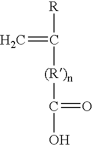
wherein R is H or a C₁ to C₁₀ hydrocarbon; R′ is a C₁ to C₁₀ hydrocarbon; and n is 0 or 1. Preferred embodiments include acrylic acid and (meth)acrylic acid.

Ethylenically copolymerizable ester monomers may be represented by the following general formula: 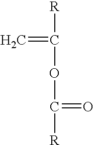
wherein each R is, independently, H or a C₁ to C₁₀ hydrocarbon. Preferred embodiments include the group consisting of methyl (meth)acrylate, ethyl (meth)acrylate, propyl (meth)acrylate, and butyl (meth)acrylate.

Ethylenically copolymerizable vinyl ester monomers may be represented by the following general formula: 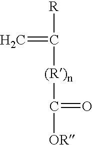
wherein each R is independently H or a C₁ to C₁₀ hydrocarbon; R′ is a C₁ to C₁₀ hydrocarbon; R″ is a C₁ to C₁₀ hydrocarbon; and n is 0 or 1. A preferred embodiment includes vinyl acetate.

In a preferred embodiment, the tie layer is selected from the group consisting of an amine-containing polymer, an epoxy-containing polymer, a carbon monoxide containing polymer, a polar copolymer, an ester polymer, a vinyl ester polymer, a polymer made from an unsaturated diacid, a polymer made from a monoester of an unsaturated diacid, a polymer made from an anhydride of an unsaturated diacid, and a polyolefin grafted with acrylic acid.

In another embodiment, the tie layer may be a blend of the one or more acid polymers, or the one or more epoxy polymers, or the one or more maleated polymers, with one or more other polymers such as α-olefinic polymers or other thermoplastic materials. The term “thermoplastic material” as used herein is defined in POLYMER TECHNOLOGY DICTIONARY 443 (Tony Whelan, ed., Chapman & Hall 1994). Such materials include polyolefins, engineering thermoplastics, thermoplastic rubbers, elastomers, plastics, and other thermoplastics known in the art, and more particularly include materials such as polypropylene homopolymer, copolymers and impact copolymers (ICP), polyethylene homopolymers and copolymers (LLDPE, LDPE, HDPE, etc.), EPDM (ethylene-propylene-diene monomer) or EP (ethylene-propylene rubber), plastomers, acrylonitrile-butadiene-styrene terpolymer, acetal polymer, acrylic polymers, cellulosics, fluoroplastics, nylon and other polyamides, polyamide-imide, polycarbonate, polyester, polyetheretherketone, polyetherimide, polyethylene, polyimide, polyphenylene oxide, polyphenylene sulfide, polypropylene, polystyrene, polysulfone, polyurethane, polyvinyl chloride, and foams of such materials, as well as blends of these materials and other materials such as described in, for example, HANDBOOK OF PLASTICS, ELASTOMERS, AND COMPOSITES 3.18-3.25 (Charles A. Harper, ed., McGraw-Hill Inc. 1992). Suitable thermoplastics or blends of thermoplastics can be made by any suitable means known in the art, and can be made either by physical blending or in-situ reactor-made, for example.

Specifically, the polyolefin may be selected from polyethylene polymers, polyethylene copolymers, polypropylene polymers, polypropylene copolymers, polypropylene impact copolymer and a blend of polypropylene impact copolymer and ethylene plastomer, and mixtures thereof. The polyolefin used in the tie-layer may have a 1% secant flexural modulus of greater than 500 MPa in one embodiment, and a 1% secant flexural modulus of greater than 200 MPa in another embodiment. In one embodiment, the polyolefin is present in the tie-layer from 30 wt % to 70 wt %, and from 40 wt % to 60 wt % in another embodiment. In yet another embodiment, the tie-layer material comprises a blend of an acid terpolymer and a polypropylene, and the tie-layer material comprises a blend of acid terpolymer and a polyethylene in another embodiment, and the tie-layer material comprises a blend of acid terpolymer, linear low density polyethylene, and high density polyethylene in yet another embodiment.

The tie-layer may have a thickness in the range of from 2.5 μm to 6 mm in one embodiment, and from 25 μm to 650 μm in another embodiment, from 2.5 μm to 400 μm in yet another embodiment, from 2 μm to 100 μm in yet another embodiment, and from 10 μm to 1 mm in yet another embodiment. Desirable ranges may include any combination of any upper tie-layer thickness limit and any lower tie-layer thickness limit described herein.

The tie-layer may also include additives as described above for the ionomer layers, such as pigments, dyes, antioxidants, antiozonants, and other agents to improve its performance. Examples include one or more of the following: heat stabilizers or antioxidants, neutralizers, slip agents, antiblock agents, pigments, antifogging agents, antistatic agents, clarifiers, nucleating agents, ultraviolet absorbers or light stabilizers, fillers, rosins or rosin esters, waxes, additional plasticizers and other additives in conventional amounts.

Backing Layer

As stated above, a “backing layer” refers to a tie layer, on the opposite side of the surface ionomer layer of the multilayered laminate. In an embodiment that includes a substrate, the backing layer secures the multilayer laminate to the substrate. In another embodiment, the backing layer material comprises a blend of tie-layer material(s), as described above, with substrate material(s) described below and/or substrate material(s) disclosed in WO 02/078953 A. However, in yet another embodiment, the backing layer comprises at least one substrate material described below.

When the backing layer comprises a blend, the blend may include from 10 wt % to 90 wt % of tie-layer material(s) by weight of the backing layer blend in one embodiment, and from 20 wt % to 80 wt % in another embodiment, and from 25 wt % to 65 wt % in yet another embodiment, and from 40 wt % to 60 wt % in yet another embodiment, a desirable embodiment of the backing layer including any combination of any upper limit and any lower limit of tie-layer materials described herein.

Metallization

In one embodiment, the invention relates to a laminate having at least one ionomer layer that has been metallized to replicate the appearance of a surface that has been metal plated. In a particular aspect of this embodiment, the laminate can be finished to replicate the look of brushed aluminum, stainless steel, chrome, or anodized metal. The laminate of the present invention generally includes a metallized ionomer layer and a tie layer.

Non-limiting examples of metals and metal alloys suitable for deposit on the ionomer layer include aluminum, chrome, gold, copper, brass, silver, indium, zinc, tin, gallium, cadmium, nickel, cobalt, iron, platinum, palladium, rhodium, stainless steel, and nichrome. Suitable methods for depositing the metal onto the ionomer layer include conventional metallization techniques such as, but not limited to vacuum metallization, sputtering, electroplating, electroless plating, thermal evaporation, painting, transfer of a preformed metal layer from a separate substrate, and depositing a random mat or fiber weave.

Laminate Formation

The method for forming the laminate of the invention generally includes depositing a metal on an ionomer layer using a procedure described above to form a metallized ionomer layer having a continuous or discontinuous layer of the metal. A tie layer or multiple tie layers are then laminated onto the metal-containing surface of the metallized ionomer, and optional backing layer(s) may then be laminated onto the tie layer. The tie layer(s) can be laminated onto the metallized ionomer layer in, for example, a secondary, off-line process, such as an extrusion process. In embodiments including a backing layer, the backing layer can be coextruded with the tie-layer or applied in a secondary, off-line process. The metallized laminate can then be formed into the approximate shape of the finished composite, which can then be utilized as a pre-form to be injection molded behind with a substrate material.

The finished laminate can be made to a variety of thicknesses depending on the process utilized to produce the end use component. For example, a metallized laminate sheet having a thickness of from 6 to 7.5 mm can be thermoformed into a “chrome-look” bumper fascia for a vehicle.

Laminate Shaping Process

Shaping the metallized laminate may be accomplished by any suitable means known in the art; for example, thermoforming and vacuum forming.

Thermoforming is a process of forming at least one pliable plastic sheet into a desired shape. Methods of thermoforming are well known in the art. For example, see McDonald, Joseph N., Thermoforming, ENCYCLOPEDIA OF POLYMER SCIENCE AND ENGINEERING, VOL. 16, John Wiley & Sons, 807-832 (New York 1989). In an embodiment of the present invention, the laminate that is formed from the at least one ionomer layer and tie-layer are thermoformed into a desirable shape, typically resembling the end use article. For illustration, an embodiment of the thermoforming sequence is described. First, a piece of the laminate, cut to the appropriate size, is placed on a shuttle rack to hold it during heating. The shuttle rack indexes into the oven which pre-heats the film before forming. Once the piece of the laminate is heated, the shuttle rack indexes back to the forming tool. The piece of the laminate is then vacuumed onto the forming tool to hold it in place and the forming tool is closed. The forming tool can be either a “male” or “female” type tool. The tool stays closed to cool the shaped laminate and the tool is then opened. The shaped laminate is then removed from the tool.

Substrate

A substrate material is a material, as described below, securable by any means known in the art, to the laminate. The substrate is contacted with and secured to the tie-layer to form a composite article.

In one embodiment, the substrate is a polyolefin. One class of polyolefins useful in this invention are thermoplastic polyolefins (TPOs). TPOs are a class of materials including blends of polypropylene and a rubber phase such as ethylene-propylene-diene rubber (EPDM) or ethylene-propylene rubber (EPR). TPOs can be made either by physical blending or in-situ reactor-made. The industry definition of TPOs typically covers blends of greater than 20 wt % rubber phase.

In another embodiment, the substrate is a copolymer of ethylene and a C₃-C₁₀ α-olefin having a density of less than 0.915 g/cc, or a density of from 0.85 to 0.915 g/cc and a melt index (MI) of from 0.10 to 20 dg/min. An example of a commercially available plastomer is EXACT 4150, an ethylene/1-hexene copolymer, containing 1-hexene in an amount of 18.5 wt %, available from ExxonMobil Chemical Company, Houston, Tex.

In another embodiment, the substrate is an ethylene homopolymer or copolymer, including low density polyethylene (LDPE), linear low density polyethylene (LLDPE), and high density polyethylene (HDPE). Such ethylene polymers are well known in the art. Examples of polyethylene polymers include: HD9856B resin, a broad molecular weight bimodal homopolymer; EXCEED 357C32 resin, an ethylene/hexene copolymer; HD-6908, a narrow molecular weight homopolymer; LL-6201, an ethylene-butene LLDPE; and EXACT plastomers, lower density ethylene-butene copolymers; all of which are available from ExxonMobil Chemical Company, Houston, Tex.

In another embodiment, the substrate is a propylene homopolymer or copolymer, including random copolymers, impact copolymers, and blends thereof with polyethylene. Such polypropylene are well known in the art. Examples of polypropylene polymers include impact copolymers such as ESCORENE PP7032E2 and PP8102E3 resins and ExxonMobil PP8114 and PP8224 resins, all of which are available from ExxonMobil Chemical Company, Houston, Tex.

In yet another embodiment, the substrate is a material selected from the group consisting of: acrylonitrile-ethylene-styrene (AES); acrylonitrile-styrene-acrylate (ASA); amorphous polyamides (made from mixed diacids, mixed diamines, or both); isobutylene-based elastomers including butyl rubbers based on isobutylene with isoprene and other monomers, and copolymers of isobutylene with alkylstyrene and other monomers, including the halogenated versions of the aforementioned elastomers; chlorosulfonated polyethylene rubbers (Hypalon™ from DuPont, Wilmington, Del.); copolyester (PETG: cyclohexane dimethanol copolyester, and other chemistries); cyclic olefin copolymer (COC); dynamically vulcanized alloys (Santoprene™ and Geoplast™ from Advanced Elastomer Systems, Akron, Ohio, Keltalloy™ from Alliance Alloys, Leominster, Mass., NexPrene™ from Harvest Polymers, Farnham, United Kingdom and similar products); liquid crystal polymers (LCP); natural rubber; general purposes rubbers; nitrile rubber; polyacrylonitrile (PAN); polyamides compounds that are impact modified with acid and/or anhydride containing polymers or rubbers; polyamide elastomers (Pebax™ from Atofina, Philadelphia, Pa., Vestamid™ from Degussa, Parsippany, N.J.); polyarylate (amorphous, aromatic polyester); polyaryletherketone (PAEK); polybenzimidazole; polybutylene terephthalate (PBT); polybutylene naphthalate (PBN); polyester elastomers (such as Hytrel™ from DuPont, Riteflex™ from Ticona, Summit, N.J., Keyflex® BT from Harvest Polymers, Farnham, United Kingdom and similar products); polyethylene naphthalate (PEN); polyetherketone (PEK); polyethersulfone (PES); polyimidesulfone (PIS); polymethacrylate acrylonitrile butadiene styrene (MABS); polyphenylsulfone (Radel™, Solvay); polymethylmethacrylate (PMMA); polystyrene; high impact polystyrene (HIPS); syndiotactic polystyrene; polystyrene maleic anhydride (SMA); polyethylene-vinyl alcohol (EVOH); sheet molding compounding (SMC) or a crosslinked, glass-reinforced, polyester/polystyrene composition; bulk molding compound (BMC); crosslinked polyurethane (RIM); reinforced polyurethane (RRIM), crosslinked dicyclopentadiene (Metton(R) RIM, Metton America, Inc, LaPorte, Tex.); silicone rubber; styrene block copolymers (SIS, SEBS); compression-molded articles of woven, glass-fiber-reinforced polypropylene fibers; or combinations thereof where appropriate.

The substrate materials described above may be used in foam form in some embodiments of the invention.

In one embodiment, the substrate materials may comprise mixtures of the substrate materials described above and/or mixtures with substrate materials disclosed in WO 02/067853 A1.

The substrate materials may also be combined with reinforcing and/or non-reinforcing materials such as glass fibers, carbon fibers, carbon black, polyaramide fibers, polyester fibers, mineral fibers, mica, talc, silica, metal whiskers, nanoclay, and the like. In a preferred embodiment, the fillers may be combined, for example in a blend, with a substrate material by any suitable means known in the art to produce a filled blend.

Embodiments of the substrate material of the invention may contain additives. Additives may be included in the substrate formulations or any other ionomer layer or tie-layer disclosed herein, as suggested by the intended uses of the materials and the knowledge and experience of the formulator. In one embodiment, included in any layer is a primary antioxidant to deter oxidative degradation of the polymer and/or an acid scavenger to neutralized acid catalyst residues which may be present in the polymer to a greater or lesser extent. Examples of the former class of additives would be hindered phenolic antioxidants and hindered amine light stabilizers, examples and the application of which are well documented in the art. Examples of the latter category of additives would be metal salts of weak fatty acids such as sodium, calcium, or zinc stearate and weakly basic, naturally occurring minerals such as hydrotalcite or a synthetic equivalent like DHT-4A (Mg_{4.5}Al₂(OH)₁₃CO_{3-3.5}H₂O, Kyowa Chemical Industry Co., Ltd., Kagawa, Japan).

Many other types of additives could be optionally included in the layer formulations of this invention such as flame retardants, lubricants, antistatic agents, slip agents, anti-blocking agents, colorants, metal deactivators, mold release agents, fillers and reinforcements, fluorescent whitening agents, biostabilizers, and others.

Composite Article Formation

Formation of the composite article may be achieved by any suitable means known to those skilled in the art. Illustrative examples include blow molding, adhesive bonding, transfer molding, cast molding, cold forming, matched-die molding, injection molding, spray techniques, or combinations thereof. See, for example, WO 02/078953 A and WO 02/078954 A.

In a particular embodiment, a trimmed, shaped metallized ionomer laminate is placed into an injection molding tool exposing at least one layer of the tie-layer, optionally a backing layer, in order to allow the tie-layer to be secured to the substrate material to be injected. Hence, the substrate material in molten form is then injected into the tool, forming a cohesive unit with the shaped laminate. The part that results is a composite article having the desired shape and geometry of the end use article.

### INDUSTRIAL APPLICATIONS

The laminates and composite articles of the present invention can be used in various applications. They may be used in interior and exterior components of appliances such as a clothing washer or a dishwasher exterior, refrigerator door exteriors, refrigerator door interiors, refrigerator housings.

The laminates and composite articles of the present invention can also be applied in construction. Some examples include tubs and showers, liners for tubs and showers, counter tops, floor coatings, laminated surface counter tops, polymer/wood composites, prefabricated building materials, sidings, sinks and sink liners, vinyl tiles, wall covering, and wood replacements for decks.

Additionally, the laminates and composite articles of the present invention have utility in electronics for CDs and DVDs as well as for housing on TVs, VCRs, computers, and stereos.

The laminates and composite articles of the present invention may also be used in a variety of sporting equipment and parts. Illustrative examples include boat hulls, canoe interiors and exteriors, boat covers, boat sails, jet skis, skis, snowboards, snowmobiles, sports helmets, stadium seats, surfboards, helmets, and tent materials.

In other applications, the present invention is applied to exterior or interior automotive parts. Illustrative examples include vehicular parts, automotive parts, airbag doors, doors, automotive door panels (interior and exterior), body chassis, body panels, bumpers, deck lids, fenders, hoods, rocker panels, mirror housings, dashboards, instrument panels, fuel tanks, grills, hopper cars, trim, pillar trim, cup holders, personal containers, and wheel covers. Applications within this category also include other minor components of any 2, 3, 4 or more wheeled vehicles including farm tractors; lawn and garden tractors; lawn mowers; large trucks; bicycles; toy wagons; parts for All Terrain Vehicles (ATVs); parts for motorcycles such as fuel tanks, scooters, seat covers, helmets, and trims. They may also be used as protective and anti-icing surfacing for airplanes, helicopters, rockets, and shuttles.

The inventive laminates and composite articles may be used in lawn, yard, and garden applications as well. Some examples are lawn/outdoor furniture, pool liners and covers, outdoor ornaments, and bird houses.

The inventive laminates and composite articles may also be used in cable jacketing, children's toys, clothing/fabric (combined with non-wovens), Gamma-radiation resistant applications, GORETEX™, luggage, and other applications for coating plastics and metals where a dull or glossy and a scratch resistant surface is desirable such as plastic microwaveable cookware, plastic paper goods, reflective signage and other reflective articles on roads and clothing, and wheels on in-line skates.

While the illustrative embodiments of the invention have been described with particularity, it will be understood that various other modifications will be apparent to and can be readily made by those skilled in the art without departing from the spirit and scope of the invention. Accordingly, it is not intended that the scope of the claims appended hereto be limited to the examples and descriptions set forth herein but rather that the claims be construed as encompassing all the features of patentable novelty which reside in the present invention, including all features which would be treated as equivalents thereof by those skilled in the art to which the invention pertains.

Terms that are or may be trademarked in some jurisdictions are used in the description. These terms are written in all capital letters, and is understood to recognize such trademarks. For brevity, markings such as “™” or “®” have not been used.

In another embodiment, this invention relates to:
1. A laminate comprising:

(a) a metallized ionomer layer;

(b) a tie layer adjoined to the metal-containing surface of the ionomer layer.
2. The laminate of paragraph 1, wherein the metal of the metallized ionomer layer is selected from the group consisting of aluminum, chrome, gold, copper, brass, and silver.
3. The laminate of paragraph 1, wherein the metal of the metallized ionomer layer is aluminum.
4. The laminate of paragraph 1, 2 3, or 4, wherein the ionomer layer comprises ethylene acrylic acid and ethylene methacrylic acid.
5. The laminate of any of paragraphs 1 to 4, wherein the laminate additionally comprises a backing layer adjoined to the tie layer.
6. The laminate of any of paragraphs 1 to 5, wherein the tie layer comprises one or more acid polymers formed by copolymerization of an unsaturated carboxylic acid and/or an ester of an unsaturated carboxylic acid, and at least one alpha-olefin.
7. The laminate of any of paragraphs 1 to 5, wherein the tie layer comprises an acid terpolymer represented by the structure:

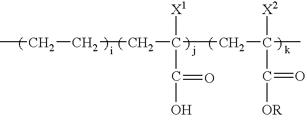

wherein X¹ and X² are each individually hydrogen or a C₁ to C₁₀ alkyl;

R is a C₁-C₁₀ alkyl;

j is 5 to 15 wt % of the total acid terpolymer;

k is 5 to 25 wt % of the total acid terpolymer; and

i is 65 to 90wt % of the total acid terpolymer.
8. The laminate of any of paragraphs 1 to 5, wherein the tie layer comprises a terpolymer of ethylene, acrylic acid, and methyl acrylate, ethyl acrylate, propyl acrylate, butyl acrylate or a combination thereof.
9. The laminate of any of paragraphs 1 to 5, wherein the tie layer comprises an ethylene/methyl acrylate/acrylic acid (E/MA/AA) terpolymer comprising 4 to 40 wt % acrylate and 1 to 15 wt % acrylic acid, based on the total weight of the polymer.
10. The laminate of any of paragraphs 1 to 5, wherein the tie layer comprises a copolymers comprising one or more C₂-C₁₀ alpha-olefins, and one or more ethylenically copolymerizable amine-containing monomers represented by the general formula: 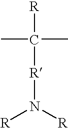
   wherein each R is independently H or a C₁ to C₁₀ hydrocarbon and R′ is a bond or a C₁ to C₁₀ hydrocarbon.
11. The laminate of any of paragraphs 1 to 5, wherein the tie layer comprises a copolymer produced by direct copolymerization of a C₁-C₁₀ alpha-olefin and an epoxy-containing monomer represented by the general formula: 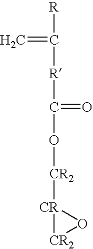
   wherein each R is independently H or a C₁ to C₁₀ hydrocarbon and R′ is independently a bond or a C₁ to C₁₀ hydrocarbon.
12. The laminate of paragraph 11, wherein the copolymer further comprises an ester monomer represented by the general formula: 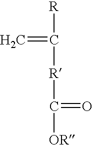
   where each R is independently H or a C₁ to C₁₀ hydrocarbon: each R′ is independently a bond or a C₁ to C₁₀ hydrocarbon, and R″ is a C₁ to C₁₀ hydrocarbon.
13. The laminate of any of paragraphs 1 to 5, wherein the tie layer comprises a C₂ to C₁₀ alpha olefin polymer grafted with an epoxy-containing monomer to produce a polymer represented by the general formula: 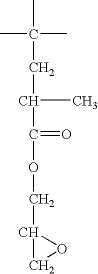
14. The laminate of any of paragraphs 1 to 5, wherein the tie layer comprises a C₂ to C₁₀ alpha olefin and an acidic monomer represented by the general formula: 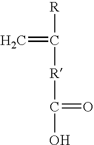
   wherein R is H or a C₁ to C₁₀ hydrocarbon and R′ is a bond a C₁ to C₁₀ hydrocarbon.
15. The laminate of any of paragraphs 1 to 5, wherein the tie layer comprises a C₂ to C₁₀ alpha olefin and an ethylenically copolymerizable ester monomers represented by the general formula: 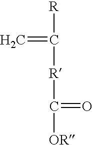
   where R is H or a C₁ to C₁₀ hydrocarbon; R′ is a bond or a C₁ to C₁₀ hydrocarbon; and R″ is a C₁ to C₁₀ hydrocarbon.
16. The laminate of any of paragraphs 1 to 5, wherein the tie layer comprises a C₂ to C₁₀ alpha olefin copolymer and vinyl ester monomer represented by the formula: 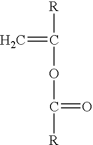
   where each R is independently H or a C₁ to C₁₀ hydrocarbon.
17. The laminate of any of paragraphs 1 to 5, wherein the tie layer comprises a C₂ to C₁₀ alpha olefin copolymer and vinyl ester monomer represented by the formula: 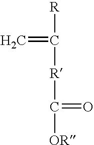
   wherein R is H or a C₁ to C₁₀ hydrocarbon; R′ is a bond or a C₁ to C₁₀ hydrocarbon, and R″ is a C₁ to C₁₀ hydrocarbon.
18. The laminate of any of paragraphs 1 to 5, wherein the tie layer comprises a C₂-C10 alpha-olefin, an ethylene vinyl ester copolymer comprising C₁ to C₁₀ acids, or an ethylene (meth)acrylate ester copolymer comprising C₁ to C₁₀ alcohols, grafted with (meth)acrylic acid represented by the general formula:

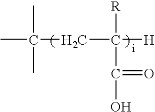

wherein each R is independently H or a C₁ to C₁₀ hydrocarbon and i is from 1 to 5.
19. The laminate of any of paragraphs 1 to 5, wherein the tie layer comprises one or more polymers comprising an unsaturated di-acids, an anhydride of an unsaturated di-acid, or a C₁-C₁₀ alkyl monoester of an unsaturated di-acid, wherein the unsaturated diacid is selected from the group consisting of maleic acid, itaconic acid, citraconic acid, and 2-pentenedioic acid.
20. The laminate of any of paragraphs 1 to 5, wherein the tie layer comprises a copolymer comprising a C₂ to C₁₀ alpha-olefin and carbon monoxide.
21. The laminate of any of paragraphs 1 to 5, wherein the tie layer comprises an ethylenically copolymerizable acidic monomer represented by the general formula: 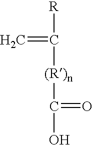
   wherein R is H or a C₁ to C₁₀ hydrocarbon;

R′ is C₁ to C₁₀ hydrocarbon; and

n is 0 or 1.
22. The laminate of any of paragraphs 1 to 5, wherein the tie layer comprises an ethylenically copolymerizable ester monomer represented by the general formula: 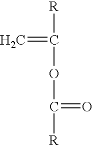
   wherein each R is H or a C₁ to C₁₀ hydrocarbon.
23. The laminate of any of paragraphs 1 to 5, wherein the tie layer comprises an ethylenically copolymerizable vinyl ester monomer represented by the general formula:

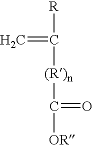

wherein R is H or a C₁ to C₁₀ hydrocarbon;

R′ is a C₁ to C₁₀ hydrocarbon;

R″ is a C₁ to C₁₀ hydrocarbon; and

n is 0 or 1
24. The laminate of any of paragraphs 1 to 5, wherein the tie layer comprises polypropylene, polyethylene, ethylene-propylene-diene copolymer, ethylene-propylene rubber, acrylonitrile-butadiene-styrene terpolymer, acetal polymer, acrylic polymer, cellulosics, fluoroplastics, a polyamide, a polyamide-imide, polycarbonate, a polyester, a polyetheretherketone, a polyetherimide, a polyimide, polyphenylene oxide, polyphenylene sulfide, polypropylene, polystyrene, polysulfone, polyurethane, polyvinyl chloride, or a combination thereof.
25. The laminate of any of paragraphs 1 to 5, wherein the tie layer comprises polyethylene, polypropylene, or a mixture thereof.
26. The laminate of any of paragraphs 1 to 5, wherein the tie layer comprises, a polyolefin selected from the group consisting of polyethylene and polypropylene, wherein the polyolefin has a 1% secant flexural modulus of greater than 500 MPa.
27. The laminate of any of paragraphs 1 to 5, wherein the tie layer comprises 30 wt % to 70 wt % of polyethylene, polypropylene, or both.
28. The laminate of any of paragraphs 1 to 5, wherein the tie layer comprises a pigment, a dye, an antioxidant, an antiozonants, a heat stabilizer, a neutralizer, a slip agent, an antiblock agents, an antifogging agent, an antistatic agent, a clarifier, a nucleating agent, an ultraviolet absorber, a light stabilizer, a filler, a rosin, a rosin ester, a wax, a plasticizer, or a combination thereof.
29. The laminate of any of paragraphs 1 to 28 wherein the laminate further comprises a backing layer adjoining to the tie layer, wherein the backing layer comprises a blend of the tie-layer material with a substrate material, and wherein the substrate material comprises a C2-C10 alpha olefin.
30. The laminate of paragraph 29, wherein the backing layer comprises 10 to 90 wt % of the tie-layer material.
31. The laminate of paragraph 29 or 30, wherein the substrate material comprises polyethylene, polypropylene, or a combination thereof.
32. A composite article comprising a substrate and the laminate of any of the preceding paragraphs.
33. The composite article of paragraph 32 wherein the tie layer is disposed between the ionomer layer and the substrate.
34. A vehicle, an appliance, an automotive part, or a boat hull comprising the composite article of paragraph 32 or 33.
35. The composite article of paragraph 32 or 33, wherein the composite article is an interior or exterior part of a wheeled vehicle.
36. A method of forming a composite article, the method comprising:

(a) depositing a metal on an ionomer layer to form a metallized ionomer layer;

(b) securing a tie layer to the metal-containing surface of the ionomer layer to form a laminate; and

(c) securing a substrate layer to the laminate to form the composite article.
37. The method of paragraph 36, wherein the metal is selected from the group consisting of aluminum, chrome, gold, copper, brass, and silver.
38. The method of paragraph 36 or 37, wherein the metal is deposited on the ionomer layer using vacuum metallization.
39. The method of paragraph 36, 37, or 38, wherein the tie layer is secured to the metallized ionomer layer in an off-line process.
40. The method of paragraph 36, 37, 38, or 39 wherein the substrate layer is secured to the laminate in an injection molding or extrusion process.

All priority documents are herein fully incorporated by reference for all jurisdictions in which such incorporation is permitted. Further, all documents cited herein, including testing procedures, publications, patents, journal articles, etc., are herein fully incorporated by reference for all jurisdictions in which such incorporation is permitted and only to the extent such disclosures are consistent with the description as herein provided.

1. A laminate comprising:
(a) a metallized ionomer layer;
(b) a tie layer adjoined to the metal-containing surface of the ionomer layer.

2. The laminate of claim 1, wherein the metal of the metallized ionomer layer is selected from the group consisting of aluminum, chrome, gold, copper, brass, and silver.

3. The laminate of claim 1, wherein the metal of the metallized ionomer layer is aluminum.

4. The laminate of claim 1, wherein the ionomer layer comprises ethylene acrylic acid and ethylene methacrylic acid.

5. The laminate of claim 1, wherein the laminate additionally comprises a backing layer adjoined to the tie layer.

6. A composite article comprising a substrate and the laminate of claim 1.

7. The composite article of claim 6, wherein the composite article is an interior or exterior part of a wheeled vehicle.

8. The composite article of claim 7, wherein the metal of the metallized ionomer layer is aluminum.

9. A method of forming a composite article, the method comprising:
(a) depositing a metal on an ionomer layer to form a metallized ionomer layer;
(b) securing a tie layer to the metal-containing surface of the ionomer layer to form a laminate; and
(c) securing a substrate layer to the laminate to form the composite article.

10. The method of claim 9, wherein the metal is selected from the group consisting of aluminum, chrome, gold, copper, brass, and silver.

11. The method of claim 9, wherein the metal is deposited on the ionomer layer using vacuum metallization.

12. The method of claim 9, wherein the tie layer is secured to the metallized ionomer layer in an off-line process.

13. The method of claim 9, wherein the substrate layer is secured to the laminate in an injection molding or extrusion process.

14. A composite article comprising:
(a) a laminate comprising:
(i) a metallized ionomer layer, and
(ii) a tie layer adjoined to the metal-containing surface of the ionomer layer; and
(b) a substrate;
wherein the tie layer is disposed between the ionomer layer and the substrate.

15. The composite article of claim 14, wherein the metal of the metallized ionomer layer is selected from the group consisting of aluminum, chrome, gold, copper, brass, and silver.

16. The composite article of claim 14, wherein the metal of the metallized ionomer layer is aluminum.

17. The composite article of claim 14, wherein the ionomer layer comprises partial salts of ethylene (meth)acrylic acid or ethylene methacrylic acid.

18. The composite article of claim 14, wherein the laminate additionally comprises a backing layer.

19. A vehicle, an appliance, an automotive part, or a boat hull comprising the composite article of claim 15.

20. A vehicle, an appliance, an automotive part, or a boat hull comprising the composite article of claim 16.

21. A vehicle, an appliance, an automotive part, or a boat hull comprising the composite article of claim 17.

22. A vehicle, an appliance, an automotive part, or a boat hull comprising the composite article of claim 18.

23. The laminate of claim 1, wherein the tie layer comprises one or more acid polymers formed by copolymerization of an unsaturated carboxylic acid and/or an ester of an unsaturated carboxylic acid, and at least one alpha-olefin.

24. The laminate of claim 1, wherein the tie layer comprises an acid terpolymer represented by the structure: 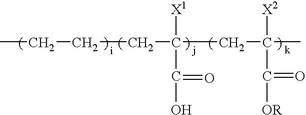
wherein X¹ and X² are each individually hydrogen or a C₁ to C₁₀ alkyl;
R is a C₁-C₁₀ alkyl;
j is 5 to 15 wt % of the total acid terpolymer;
k is 5 to 25 wt % of the total acid terpolymer; and
i is 65 to 90wt % of the total acid terpolymer.

25. The laminate of claim 1, wherein the tie layer comprises a terpolymer of ethylene, acrylic acid, and methyl acrylate, ethyl acrylate, propyl acrylate, butyl acrylate or a combination thereof.

26. The laminate of claim 1, wherein the tie layer comprises an ethylene/methyl acrylate/acrylic acid (E/MA/AA) terpolymer comprising 4 to 40 wt % acrylate and 1 to 15 wt % acrylic acid, based on the total weight of the polymer.

27. The laminate of claim 1, wherein the tie layer comprises a copolymers comprising one or more C₂-C₁₀ alpha-olefins, and one or more ethylenically copolymerizable amine-containing monomers represented by the general formula: 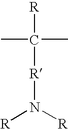
wherein each R is independently H or a C₁ to C₁₀ hydrocarbon and R′ is a bond or a C₁ to C₁₀ hydrocarbon.

28. The laminate of claim 1, wherein the tie layer comprises a copolymer produced by direct copolymerization of a C₁-C₁₀ alpha-olefin and an epoxy-containing monomer represented by the general formula: 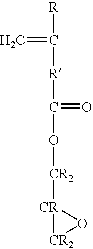
wherein each R is independently H or a C₁ to C₁₀ hydrocarbon and R′ is independently a bond or a C₁ to C₁₀ hydrocarbon.

29. The laminate of claim 28, wherein the copolymer further comprises an ester monomer represented by the general formula: 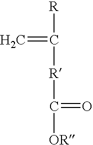
where each R is independently H or a C₁ to C₁₀ hydrocarbon: each R′ is independently a bond or a C₁ to C₁₀ hydrocarbon, and R″ is a C₁ to C₁₀ hydrocarbon.

30. The laminate of claim 1, wherein the tie layer comprises a C₂ to C₁₀ alpha olefin polymer grafted with an epoxy-containing monomer to produce a polymer represented by the general formula:

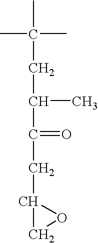

31. The laminate of claim 1, wherein the tie layer comprises a C₂ to C₁₀ alpha olefin and an acidic monomer represented by the general formula: 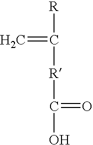
wherein R is H or a C₁ to C₁₀ hydrocarbon and R′ is a bond a C₁ to C₁₀ hydrocarbon.

32. The laminate of claim 1, wherein the tie layer comprises a C₂ to C₁₀ alpha olefin and an ethylenically copolymerizable ester monomers represented by the general formula: 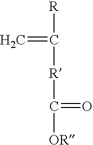
where R is H or a C₁ to C₁₀ hydrocarbon; R′ is a bond or a C₁ to C₁₀ hydrocarbon; and R″ is a C₁ to C₁₀ hydrocarbon.

33. The laminate of claim 1, wherein the tie layer comprises a C₂ to C₁₀ alpha olefin copolymer and vinyl ester monomer represented by the formula: 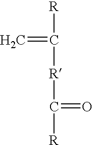
where each R is independently H or a C₁ to C₁₀ hydrocarbon.

34. The laminate of claim 1, wherein the tie layer comprises a C₂ to C₁₀ alpha olefin copolymer and vinyl ester monomer represented by the formula: 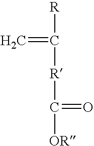
wherein R is H or a C₁ to C₁₀ hydrocarbon; R′ is a bond or a C₁ to C₁₀ hydrocarbon, and R″ is a C₁ to C₁₀ hydrocarbon.

35. The laminate of claim 1, wherein the tie layer comprises a C₂-C₁₀ alpha-olefin, an ethylene vinyl ester copolymer comprising C₁ to C₁₀ acids, or an ethylene (meth)acrylate ester copolymer comprising C₁ to C₁₀ alcohols, grafted with (meth)acrylic acid represented by the general formula: 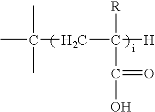
wherein each R is independently H or a C₁ to C₁₀ hydrocarbon and i is from 1 to 5.

36. The laminate of claim 1, wherein the tie layer comprises one or more polymers comprising an unsaturated di-acids, an anhydride of an unsaturated di-acid, or a C₁-C₁₀ alkyl monoester of an unsaturated di-acid, wherein the unsaturated diacid is selected from the group consisting of maleic acid, itaconic acid, citraconic acid, and 2-pentenedioic acid.

37. The laminate of claim 1, wherein the tie layer comprises a copolymer comprising a C₂ to C₁₀ alpha-olefin and carbon monoxide.

38. The laminate of claim 1, wherein the tie layer comprises an ethylenically copolymerizable acidic monomer represented by the general formula: 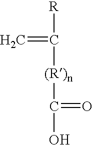
wherein R is H or a C₁ to C₁₀ hydrocarbon;
R′ is C₁ to C₁₀ hydrocarbon; and
n is 0 or 1.

39. The laminate of claim 1, wherein the tie layer comprises an ethylenically copolymerizable ester monomer represented by the general formula: 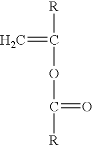
wherein each R is H or a C₁ to C₁₀ hydrocarbon.

40. The laminate of claim 1, wherein the tie layer comprises an ethylenically copolymerizable vinyl ester monomer represented by the general formula: 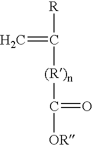
wherein R is H or a C₁ to C₁₀ hydrocarbon;
R′ is a C₁ to C₁₀ hydrocarbon;
R″ is a C₁ to C₁₀ hydrocarbon; and
n is 0 or 1

41. The laminate of claim 1, wherein the tie layer comprises polypropylene, polyethylene, ethylene-propylene-diene copolymer, ethylene-propylene rubber, acrylonitrile-butadiene-styrene terpolymer, acetal polymer, acrylic polymer, cellulosics, fluoroplastics, a polyamide, a polyamide-imide, polycarbonate, a polyester, a polyetheretherketone, a polyetherimide, a polyimide, polyphenylene oxide, polyphenylene sulfide, polypropylene, polystyrene, polysulfone, polyurethane, polyvinyl chloride, or a combination thereof.

42. The laminate of claim 1, wherein the tie layer comprises polyethylene, polypropylene, or a mixture thereof.

43. The laminate of claim 1, wherein the tie layer comprises, a polyolefin selected from the group consisting of polyethylene and polypropylene, wherein the polyolefin has a 1% secant flexural modulus of greater than 500 MPa.

44. The laminate of claim 1, wherein the tie layer comprises 30 wt % to 70 wt % of polyethylene, polypropylene, or both.

45. The laminate of claim 1, wherein the tie layer comprises a pigment, a dye, an antioxidant, an antiozonants, a heat stabilizer, a neutralizer, a slip agent, an antiblock agents, an antifogging agent, an antistatic agent, a clarifier, a nucleating agent, an ultraviolet absorber, a light stabilizer, a filler, a rosin, a rosin ester, a wax, a plasticizer, or a combination thereof.

46. A laminate comprising:
(a) a metallized ionomer layer;
(b) a tie layer adjoined to the metal-containing surface of the ionomer layer; and
(c) a backing layer adjoining to the tie layer, wherein the backing layer comprises a blend of the tie-layer material with a substrate material, and wherein the substrate material comprises a C2-C10 alpha olefin.

47. The laminate of claim 46, wherein the backing layer comprises 10 to 90 wt % of the tie-layer material.

48. The laminate of claim 46, wherein the substrate material comprises polyethylene, polypropylene, or a combination thereof.
